(19) United States
(12) Patent Application Publication
(10) Pub. No.: US 2011/0311347 A1
(43) Pub. Date: Dec. 22, 2011

(54) Flash Steam Turbine

(76) Inventor: John Marsden, Cut Off, LA (US)

(21) Appl. No.: 13/159,275

(22) Filed: Jun. 13, 2011

Related U.S. Application Data
(60) Provisional application No. 61/355,457, filed on Jun. 16, 2010.

(51) Int. Cl. F03B 3/00; F03B 1/00

(52) U.S. Cl. 415/1; 415/80

(57) ABSTRACT

A flash steam powered flywheel turbine is provided comprising a stator housing with an internal channel for the flash and expansion of steam, the channel having a plurality of jet orifices to direct jets of expanding steam toward a rotary flywheel which is fixed to a rotational shaft within the stator housing. The rotary flywheel. is fitted with a plurality of inlet jet passages generally extending radially inwardly from the peripheral surface of the flywheel and oriented such that the force of expanding and impinging steam causes the flywheel to rotate about its central axis. Each inlet jet passage merges into one or more outlet jet passages oriented generally laterally such that the force of discharging steam causes further rotation in reaction to the discharging steam. The discharging steam is directed against steps or depressions formed on the inner lateral walls of the stator housing to add a jet-propulsion effect. in a clean and renewable manner, rotational energy and power will be generated, and the flywheel turbine and rotational shaft can be used to drive an electricity generator or as a prime mover.

### CROSS REFERENCE TO RELATED APPLICATIONS

This application claims priority to U.S. Provisional Patent Application Ser. No. 61/355,457, filed Jun. 16, 2010, the contents of which are hereby incorporated by reference herein.

### BACKGROUND

1. Field of the Invention

This invention concerns renewable energy resources and relates generally to rotary turbines for generating electrical power, and more particularly to a rotary flywheel steam turbine for use with generating or storing rotational energy and electrical power.

1. Description of Related Art

As conventional hydrocarbon fuel resources may become less abundant and more expensive, and pose a danger to the environment such as the 2010 oil spill in the Gulf of Mexico, a worldwide interest has arisen in the development of alternative energy resources, including renewable energy resources and waste heat recovery resources. The conversion of fuels into electricity has long been the focus of engineers. The supply of fuel to a generation site, as well as the reliability, cost and renewability of the supply, is factored into the engineering decision process.

At the present time, machines employed for the production of mechanical energy by means of the expansion of compressed vapor or gas consist, primarily, of reciprocating engines and turbines. Reciprocating engines, often called “positive displacement” engines, employ the reciprocating motion of pistons and other mechanical components to accomplish the energy conversion process. In comparison, turbines are generally rotational machines which often employ aerofoil-like lifting surfaces such as blades installed on a rotational armature to accomplish the energy conversion process. Both of these machines may feature the use of either externally produced or internally produced compressed gaseous or vaporous working fluid.

Although the turbine principle of utilizing the heat energy in steam and converting it into useful work has been experimented upon for many years, it is only since the inauguration of the twentieth century that steam turbines have been brought to the front as efficient power producers. In a steam turbine, generally, the expansive force of the steam is made to do work, and an important element is utilized, viz., the kinetic energy, or heat energy latent in the steam, which manifests itself in the rapid vibratory motion of the particles of steam expanding from a high to a low pressure, and this motion a steam turbine transforms into work.

A steam turbine is conventionally a mechanical device that extracts thermal energy from pressurized steam and converts it into rotary motion. Because a turbine generates rotary motion, it is particularly suited to be used to drive an electrical generator. Generally, two transformations take place in a steam turbine; first, from thermal to kinetic energy; and second, from kinetic energy to useful work.

As a renewable energy resource, the thrust of waste heat recovery technology is to make use of thermal energy normally discarded from a primary power conversion process. In many prior art devices, discarded thermal energy (i.e., waste heat) is harnessed to drive additional thermo-fluid processes that can yield additional energy (i.e., electricity).

Referring to U.S. Pat. No. 7,637,108, which is incorporated herein by reference, prior art waste heat recovery systems direct a supply of waste heat measured at temperatures between 300° F. to 800° F. from a heat source to an evaporator. The waste heat is transferred to a working fluid in the evaporator. The working fluid is evaporated; changes from a liquid to a vapor, in the evaporator and is expanded through a turbine. The expansion of the working fluid through the turbine drives the turbine. The turbine, in turn, drives an electric generator coupled to the turbine. The generator produces electrical power. The working fluid flows to a condenser and changes phase from vapor to a liquid. The working fluid is then pumped back to the evaporator and begins the cycle again. This above described system employs a closed loop Organic Rankin Cycle to produce electricity from a thermal energy source, such as waste heat. This example illustrates that the prior art waste heat recovery systems have utilized turbines to produce electricity as a renewable energy resource. Conventional turbines often require complex machinery in order to try and capture the thermal energy for reuse as mechanical energy and electricity. What is needed in the art is a steam turbine to convert waste heat from a source such as an engine or a power plant into useful power that is simple, reliable, efficient and cost effective.

As may be gleaned from the above example system in U.S. Pat. No. 7,637,108, a very important element in the production of mechanical energy by means of the expansion of compressed vapor or gas is the type, design, configuration and mechanical operation of the turbine through which the working fluid flows to drive the turbine which, in turn, drives the generator.

Steam turbines have heretofore been proposed in the art in which an outer ring and an inner steam injection means are provided, and the steam ejected out of the inner ejection means impacts a receiving surface of the outer ring, and either the outer ring or the inner arms Or discs, or both, are driven by force exerted by the steam impingement: Examples of patents which employ this technology are U.S. Pat. Nos. 36,164; 11,912; 927,639; 969,070; 2,253,005; 3,026,088; 4,769,987 and 6,565,310, which are incorporated herein by reference. In these turbines, generally, pressurized steam is first flowed through a shaft disposed along a central axis, then in turn, flowed orthogonally (i.e., at a right angle) and radially outwardly into passages within a disc fixed to the shaft, then in turn, flowed orthogonally (again), or curvedly through the disc passages, and then finally discharged from the disc to impact an outer ring. These turbines rely on the initial velocity of the steam to drive the turbine, and steam velocity is lost through the multiple turns and curves as it is flowed to and through the turbine, thereby limiting and lowering the efficiency of the turbine and the energy conversion process. A need therefore continues to exist for a rotary steam turbine that is not limited by reliance upon an initial velocity of steam which is in part lost when flowed through a hollow shaft to reach the rotor disc and in turn flowed through multiple turns or curves.

U.S. Pat. Nos. 5,385,446 and 5,624,235 disclose steam turbines in which working fluid flows in an axial direction through multi-staged stator blades and turbine blades. In these turbines, there are spacings between an inner wall of a turbine housing and outer peripheries of the turbine blades, and unused working fluid escapes through those spacings without impinging upon the turbine blades. Thus, the turbine becomes low in efficiency, large in size and high in manufacturing and maintenance costs. U.S. Pat. No. 5,071,312 discloses a turbine having a rotor which is a disc with blades projecting axially from its face working with rotor blades on a disc-like stator, and U.S. Pat. No. 6,425,737 B1 discloses a turbine using two flywheel discs having rotor blades and a stator having stator blades, where the embodiments in both patents rely upon the velocity of a jet stream of steam passing therethrough and impinging upon said blades. Thus, these turbines are limited in power and efficiency by the velocity of the impinging steam upon the blades, and are limited economically by the complexity and number of parts. By a similar nature, the historical De Laval turbine accelerated steam to full speed before running it against a turbine disc or blade and was said to be limited as to its efficiency and operation in a similar nature.

U.S. Pat. No. 6,024,549 discloses a vane type rotary device which consists primarily of a circular rotational armature concentrically installed on a rotational shaft such as to rotate on an axis which is parallel to, but offset from, the axis of the containment cylinder. The circular armature is fitted with a plurality of displacer rotor vanes which slide radially inwardly and radially outwardly and intersect impinging steam streamed from a nozzle or injector. These turbines are limited in power and efficiency by the velocity of the impinging steam that is streamed against the radially sliding displacer vanes, and in addition, the complexity, wear, and increased balancing problems caused by this offset axis arrangement thus substantially detract from the disclosed benefits of such type of turbine.

Furthermore, while the majority of conventional steam turbines are purely rotational machines which employ aerofoil-like lifting surfaces such as blades installed on a rotational armature to accomplish the energy conversion process, such blades are often numerous in count and highly delicate (e.g., the incidental introduction of condensate in place of pure steam could cause material failures, i.e., cracking and fracture, in the blades), thereby increasing the complexity, the size and the cost of manufacture and maintenance.

A need therefore continues to exist for a turbine that utilizes the power of flash steam and the expansion of steam directly within the turbine, while offering the advantages of reduced mechanical complexity and superior power density.

A need therefore continues to exist for a rotary steam turbine which operates with greater efficiency and which overcomes the above-noted disadvantages of the prior art steam turbines.

A need therefore continues to exist for a rotary steam turbine that utilizes a smaller volume of steam. while maintaining superior power density.

A need therefore continues to exist for a rotary steam turbine that is not limited by reliance upon the velocity of the steam that is streamed from a nozzle aimed at the turbine rotor.

A need therefore continues to exist for a rotary steam turbine that is not limited in power and efficiency by the velocity of steam from a nozzle aimed at the turbine rotor.

A need therefore continues to exist for a rotary steam turbine that is not limited by the sole impingement of steam upon blades in a singular motion or reaction.

A need therefore continues to exist for a rotary steam turbine that is not limited by the sole expulsion of steam from a rotor disc in a singular motion or reaction.

A need therefore continues to exist for a rotary steam turbine with less fragile and less numerous parts.

A need continues to exist for a power generation source and a power storage source which is clean, which is renewable, which recovers discarded thermal energy, and which will be useful for end uses such as driving a generator to produce electrical power, or serving as an efficient back up energy storage source itself as a generator for use in a building or a house where venting of exhaust fumes (e.g., from burning hydrocarbons) is a problem, or generating electrical power to charge batteries for a hybrid automobile.

In view of the above, currently, a need exists for a new turbine apparatus that is more efficient than conventional steam turbines and is better suited for power generation and power storage applications.

It is an object of the present invention to provide a steam turbine which utilizes the power or force of flash steam and the expansion of the steam directly within the turbine.

It is another object of the present invention to provide a turbine which has a high operating efficiency, and is compact in structure, small in size and low in manufacturing costs and operating costs.

It is an object of the present invention to provide the advantage of a steam turbine with a reduced mechanical complexity and superior power density.

It is a further object of the present invention to provide a steam powered rotary turbine which may operate at high rotational speeds while avoiding the complexity and wear of numerous sliding parts, and avoiding the balancing problems of an offset axis arrangement.

It is thus a principal object of the invention to provide a flash steam powered rotary turbine which is capable of, and suitable for, uses of the type noted above and other uses, while minimizing the amount of pollution generated in its operation.

To overcome the limitations of the prior art described above, and to overcome other limitations that will become apparent upon reading and understanding the present specification, embodiments of the present invention provide a cost effective method and simplified means for combining two essential elements which enable the conversion of heat energy into rotational energy. Embodiments of the present invention utilize the latent energy in flash steam and the expansion of steam.

### SUMMARY

The following presents a simplified summary of the present disclosure in a simplified form as a prelude to the more detailed description that is presented herein.

The above and other objects of the present invention are achieved by providing a rotary flywheel turbine which is powered by flash steam or other working fluid and which comprises a rotary flywheel within a stationary stator housing.

The present invention is directed to a rotary flywheel turbine that is powered by flash steam or other working fluid and that is more efficient than conventional steam turbines and is better suited for power generation and power storage applications.

The rotary flywheel turbine of the present invention comprises a rotary flywheel and a stationary stator housing sized to closely surround the rotary flywheel. The rotary flywheel is fixed to a rotational shaft which is supported by low-friction support bearings such that the rotary flywheel may rotate freely within the stator housing. Energy is stored in the rotary flywheel as kinetic energy, or more specifically, rotational energy.

The flywheel has a plurality of inlet jet passages spaced along the peripheral surface of the flywheel. Each inlet jet passage extends radially inward from the peripheral surface of the flywheel and allows for the entering and communication of steam into the flywheel. Within the rotary flywheel, each inlet jet passage merges with outlet jet passages that extend laterally toward the lateral surface of the flywheel. Each outlet jet passage allows for the communication and discharge of steam from the flywheel. The inlet jet passages are designed to receive expanding steam in a predetermined direction so as to facilitate rotation of the flywheel in one rotational direction, such as a counterclockwise (CCW) direction. The outlet jet passages are designed to allow the discharge of the expanding steam in a predetermined direction so as to facilitate rotation of the flywheel in the same rotational direction, such as the counterclockwise (CCW) direction. The inlet jet passages and outlet jet passages are sized to efficiently receive and discharge, respectively, the expanding steam.

Relative to the stator housing, the force of the flash steam as it expands and enters the inlet jet passages of the flywheel causes the flywheel to rotate in one rotational direction, and the force of the steam as it expands and exits the outlet jet passages of the flywheel also causes the flywheel to rotate in the same rotational direction.

The stator housing closely surrounds the flywheel and has a vacuum maintained by an exhaust port connected by piping or hoses to a vacuum generator. The stator housing comprises a first end and a second end, where the first end and second end are secured together by conventional means, such as fasteners or welding. The first end of the stator housing has a plurality of ports along its perimeter that allow for the communication of heated condensate into the stator housing. As heated condensate enters the stator housing through the ports, it flashes to steam and expands, as a result of the low pressure (i.e., vacuum) in the stator housing.

The second end of the stator housing has a stationary ring that is sized to closely fit within the first end of the stator housing. The ring has a channel, for the flash and expansion of steam and for the communication of expanding steam, along the outer perimeter of the ring within the stator housing. The channel has a plurality of jet orifices arranged about the periphery of the ring to direct jets of expanding steam into the space between the ring of the stator housing and the peripheral surface of the flywheel which contains the inlet jet passages.

The stator housing further comprises a plurality of steps, flats or depressions along the inner walls of the stator housing, in alignment with the outlet jet passages of the flywheel, so as to present impacts surfaces against which steam exiting the outlet jet passages will strike.

The impact of the steam against these steps also causes the flywheel to rotate in the same rotational direction.

Expanding steam enters the inlet jet passages of the flywheel, exits the outlet jet passages of the flywheel and impacts the steps of the stator housing, causing the rotary flywheel to rotate in a unified rotational direction, enabling an embodiment of the present invention to utilize multiple impinging forces, discharging forces and impacting forces of the expanding steam to drive the rotary flywheel, and thereby overcome previous limitations of impingement of steam in a singular motion or reaction. In this manner, a highly efficient and clean generation of power from flash steam and the expansion of steam is effected.

The rotational shaft connected to the rotary flywheel transfers this rotational mechanical energy, either directly or indirectly such as through a drive train, to a power generator, such as an electric generator.

In addition, rotational energy is stored in the rotation of the flywheel and can be drawn upon when needed. The rotary flywheel turbine of the present invention itself is a kinetic, or mechanical battery, spinning at high speeds to store energy that is instantly available when needed.

Electricity may be generated or stored very efficiently because the rotary flywheel turbine utilizes flash steam and the expansion of steam rather than relying on mere steam velocity, in an embodiment of the present invention.

One of the benefits of using a rotary flywheel in an embodiment of the present invention is that energy is stored in the rotational movement of the rotary flywheel, and when needed one can use that rotational force to make electricity using conventional means by decreasing its speed and extracting energy from it. A flywheel can be used as a mechanical battery, i.e., a mechanical means of storing energy. Flywheels store energy mechanically in the form of kinetic energy. A flywheel stores energy more efficiently than a battery and can accept and deliver energy more rapidly than a battery. As one embodiment of the present invention, the flash steam rotary flywheel turbine could be used as a mechanical battery.

The heat required for boiling the condensate and supplying the steam can be derived from various sources. The heat source could be a nuclear reactor, geothermal energy, internal combustion engines, gas turbines, industrial manufacturing processes that continuously produce thermal energy, incinerators, boilers, water heaters, methane, bio-gas sources, and the like. In one embodiment of the invention, a method of using flash steam to power a rotary flywheel turbine comprises harnessing waste heat produced from a prime mover, directing said waste heat to a boiler coupled to said rotary flywheel turbine, transferring thermal energy from said waste heat to condensate contained in said boiler, directing said condensate to the rotary flywheel turbine fluidly coupled to said boiler, flashing said condensate to steam within the rotary flywheel turbine coupled to said boiler, creating rotational mechanical energy in said rotary flywheel turbine using said flash steam, transferring said rotational mechanical energy to an electricity generator via a shaft of said rotary flywheel turbine, exhausting expanded steam from the rotary flywheel turbine; and directing said expanded steam to a condenser for transforming said steam to condensate, said condenser fluidly coupled to said rotary flywheel turbine.

In one embodiment of the present invention, the heat from a power plant may be utilized to heat directly or indirectly the condensate which would be flashed steamed thereby driving the rotation of the present invention and thereby generating electrical energy from the rotating flywheel.

In another embodiment of the present invention, the excess steam from a power plant may be utilized to drive the rotation of the flywheel turbine thereby generating electrical energy from the rotating flywheel. (ie., excess steam may be generated to be utilized as process steam).

In another embodiment of the present invention, multiple flywheels and stator housings may be stacked together, with one or more flywheels rotating in an opposite direction, allowing for the slowing down or speeding up of the rotation.

In yet another embodiment of the present invention, multiple rotary flywheels may be fixed to the same rotational shaft and disposed within a modified stator housing, where the rotary flywheels may be oriented to rotate in a unified rotational direction, allowing for the generation of additional energy and power. In a slight modification of this embodiment, one or more of the rotary flywheels may be oriented to rotate in a rotational direction opposite of one or more other rotary flywheels, allowing for the slowing or braking of the rotation or the reversing of the rotational direction.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 is a perspective view, partly in cross section, of an exemplary rotary flywheel turbine, according to a preferred embodiment of the present invention;

FIG. 2 is an exploded view of an exemplary rotary flywheel turbine, according to a preferred embodiment of the present invention;

FIG. 3 is a cross sectional view along the cutting view 3-3 of FIG. 1, according to a preferred embodiment of the present invention;

FIG. 4 is a perspective view of the first end of the stator housing of an exemplary rotary flywheel turbine, according to a preferred embodiment of the present invention;

FIG. 5 is a perspective view of the second end of the stator housing of an exemplary rotary flywheel turbine, according to a preferred embodiment of the present invention;

FIG. 6 is a perspective view of the rotary flywheel of an exemplary rotary flywheel turbine, according to a preferred embodiment of the present invention;

FIG. 6A is an enlarged perspective view, partly in cross section, of the rotary flywheel of an exemplary rotary flywheel turbine, illustrating the principal geometric features of inlet and out jet passages disposed along the periphery of the rotary flywheel, and illustrating the peripheral surface and the lateral surface of the rotary flywheel, according to a preferred embodiment of the present invention;

FIG. 7 is a cross section of another exemplary rotary flywheel turbine with three rotary flywheels fixed to the same rotational shaft, according to a further preferred embodiment of the present invention;

FIG. 8 is a schematic of a system employing the rotary flywheel steam turbine, according to a preferred embodiment of the present invention; and

APPENDIX A includes several attachments pertinent to this application.

### DETAILED DESCRIPTION

Persons of ordinary skill in the art will realize that the following disclosure is illustrative only and not in any way limiting. Other embodiments of the disclosure will readily suggest themselves to such skilled persons having the benefit of this disclosure.

The present disclosure is directed to embodiments of a rotary flywheel turbine of the present invention that converts thermal energy from a source into rotational mechanical energy in the rotation of the rotary flywheel turbine which is used to power an electricity generator. For the purposes of this disclosure, the preferred embodiment of the rotary flywheel turbine is intended to be driven by heated condensate, flash steam and the expansion of steam in a closed loop system.

When high temperature, high pressure condensate is discharged to a lower pressure, the discharged condensate instantly changes back into steam. This is known as “flash steam.” Flash steam is steam created when condensate at a higher pressure and temperature is released to a lower pressure and cannot exist as a liquid at the higher temperature. When the pressure is reduced, sensible heat is released. The excess heat will be absorbed in the form of latent heat, causing part of the condensate to “flash” into steam.

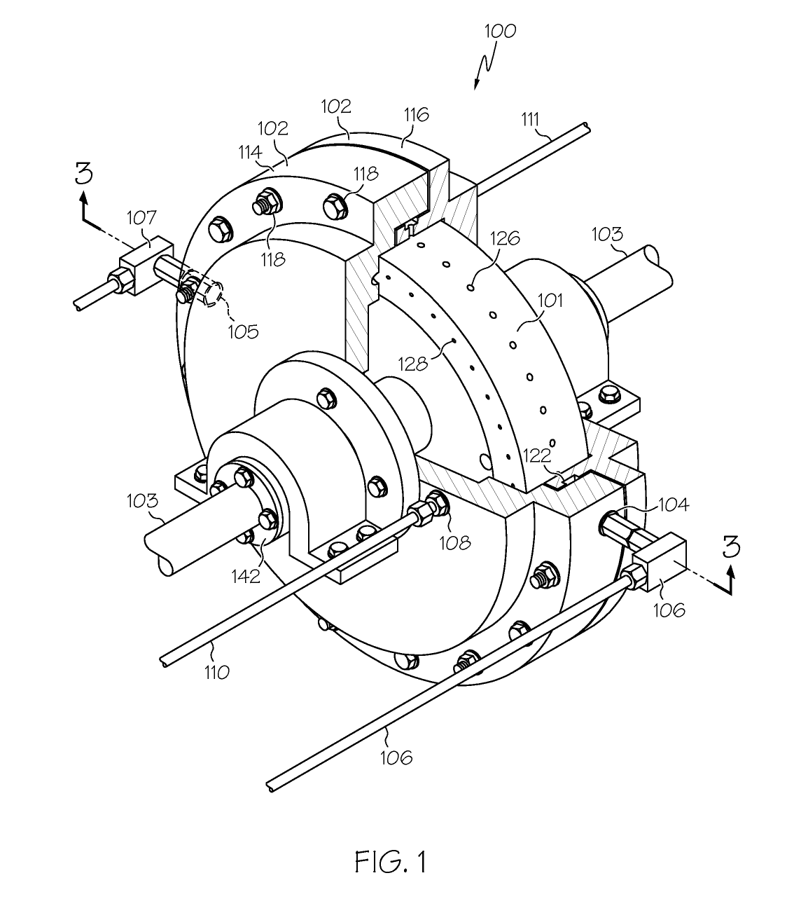

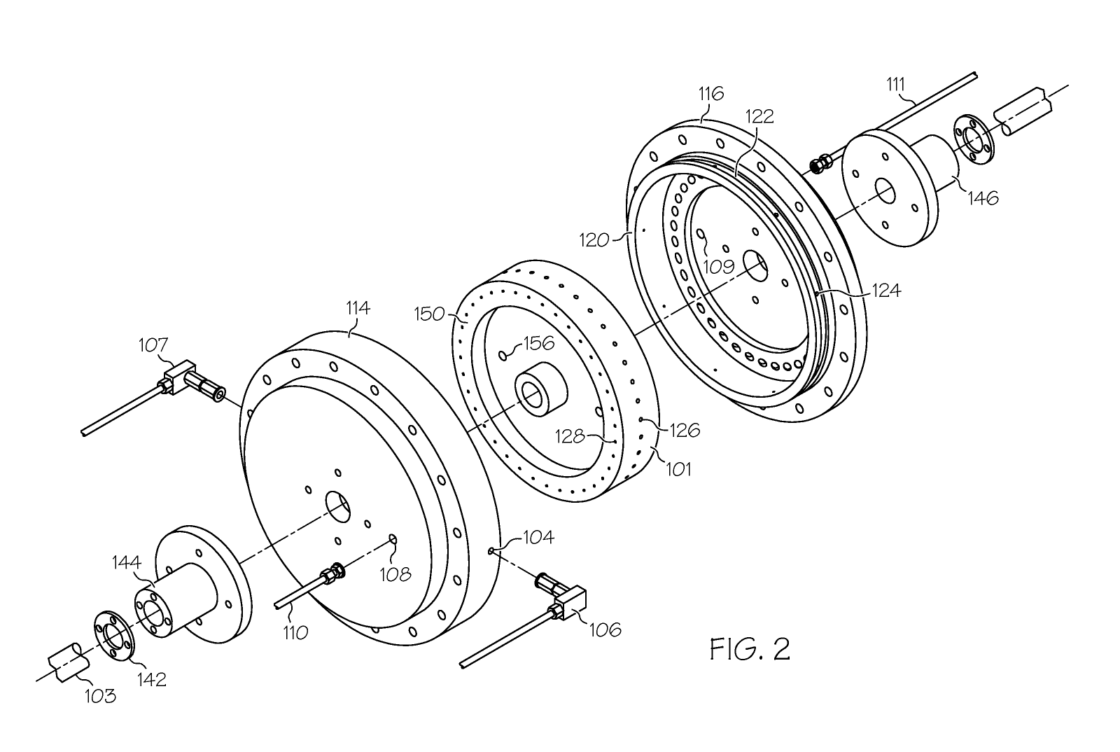

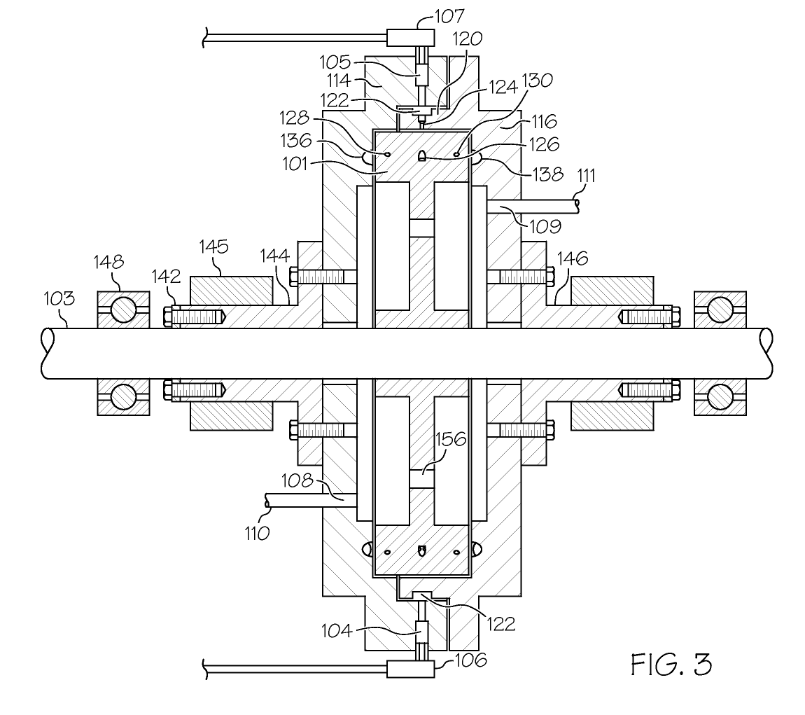

Referring initially to FIG. 1, FIG. 2, and FIG. 3, the basic constructional details and principles of operation of the flash steam-powered rotary flywheel turbine 100 according to a preferred embodiment of the present invention will be discussed.

In FIG. 1, a flash steam-powered rotary flywheel turbine 100 according to a preferred embodiment of the present invention is provided. In FIG. 1, the rotary flywheel turbine 100 comprises a rotary flywheel 101 fixed to a rotational shaft 103, and a stationary stator housing 102 closely surrounding said rotary flywheel 101.

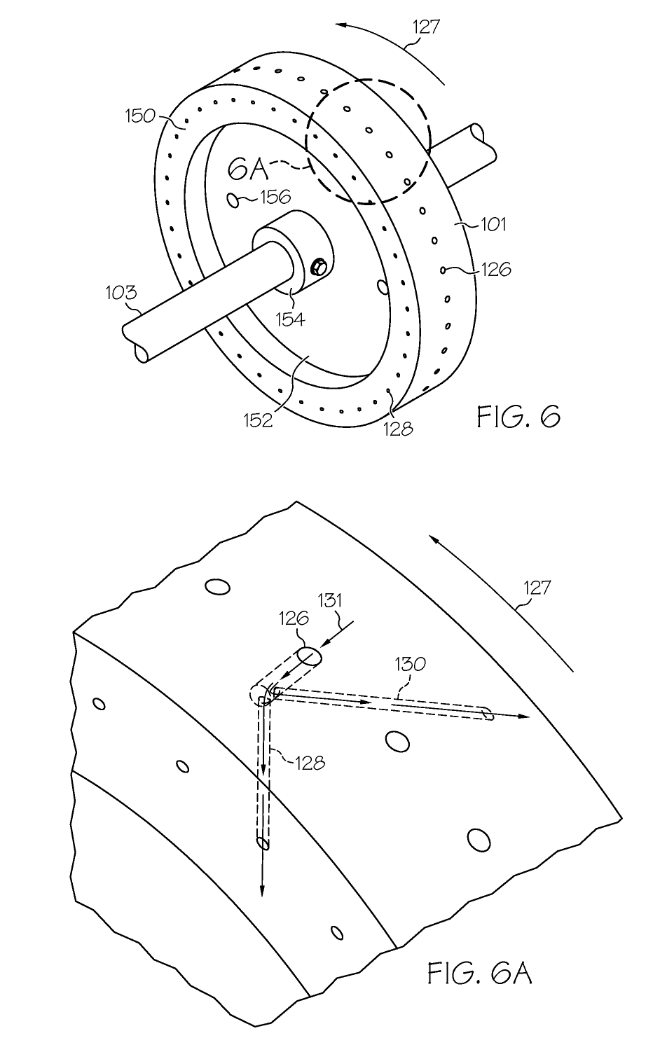

The rotary flywheel 101 is centrally fixed to the rotational shaft 103, as shown in FIG. 3 and FIG. 6, and the rotational shaft 103 is supported by low-friction, rotational shaft support bearings 148, shown schematically at FIG. 3, such that the rotary flywheel 101 freely rotates about a central axis located at a central point of the stator housing 102. This may be accomplished by providing, for example, a plurality of spaced apart rollers or bearing such as ball bearings or pillow block bearings which maintain the rotational shaft 103 in position, but permit the rotational shaft 103 to rotate within the confines of the bearings.

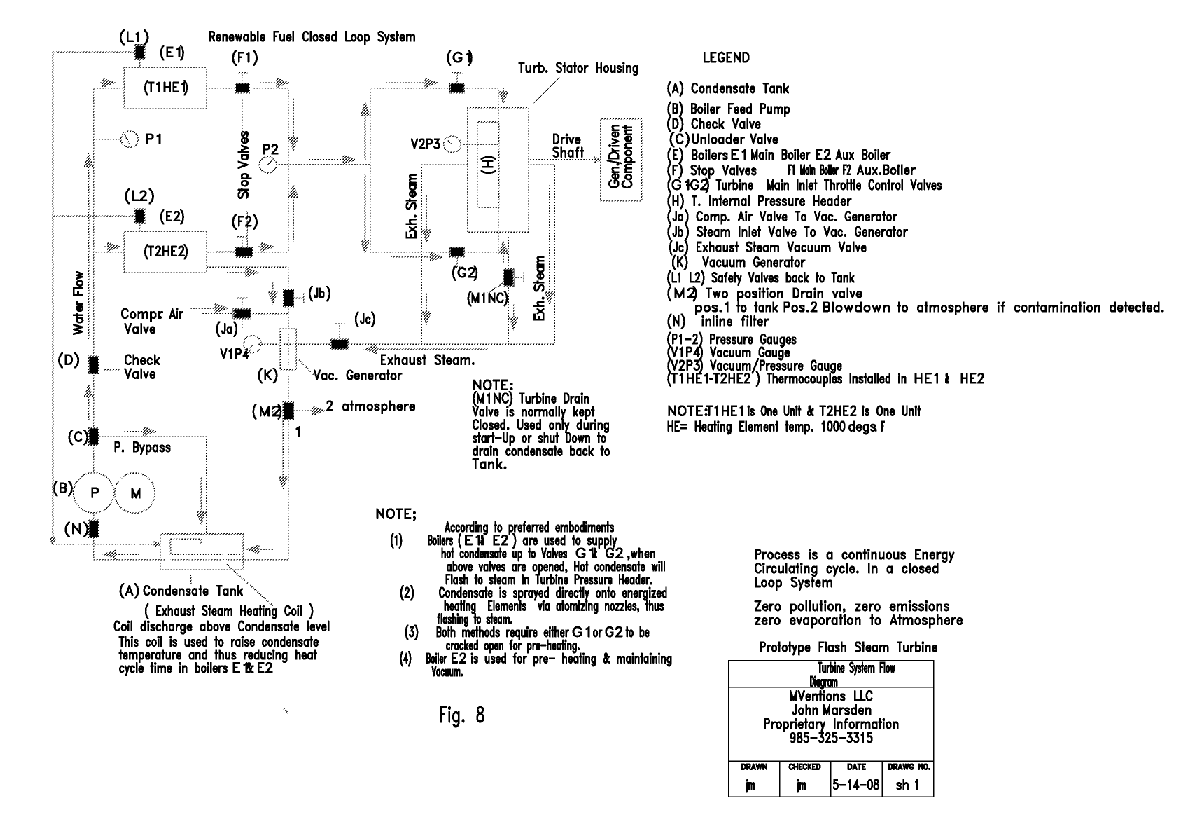

In FIG. 1, the stator housing 102 comprises first and second inlet ports 104, 105 for the communication of heated condensate into the stator housing 102 by connection to a source (FIG. 8) by tubing or piping 106, 107 (FIGS. 1, 2, and 3; and shown schematically at FIG. 8), and first and second outlet ports 108, 109 for the exhaust of steam from the housing 102 and to maintain a vacuum within the housing 102 by connection to a vacuum generator (FIG. 8) by tubing or piping 110, 111.

As will be discussed in greater detail with respect to subsequent drawing figures, the stationary housing 102 is operatively coupled to a source of heated condensate, such as a boiler (shown schematically at FIG. 8), in a manner that will be known in the art, such that heated condensate can be supplied to and through the fluid inlet ports 104, 105. It is to be noted that other gases or fluids could be used with this turbine 100, however the discussion herein, for illustrative purposes, focuses on the preferred use of heated condensate and flash steam.

In FIG. 1, the stator housing comprises a first end 114 and a second end 116, and the first end 114 and second end 116 are secured together by bolts 118. A person of ordinary skill in the art would appreciate that the first end 114 and second end 116 may be secured together by conventional means such as fasteners or welding or polymers.

The inlet ports 104, 105 are disposed around the perimeter of the first end 114 and are arranged to introduce heated condensate into the stator housing 102. The introduction of heated condensate into the fluid inlet ports 104, 105 may be controlled by main control valves 112, 113 (shown schematically at FIG. 8, where referred to as “Turbine Main Inlet Throttle Control Valves”) that are disposed within the condensate lines 106, 107 adjacent to the fluid inlet ports 104, 105. Two inlet ports 104, 105 are shown in FIG. 1, but it is understood that at least one or more are provided and that more may be provided around the perimeter of the first end 114 of the stator housing 102 according to another embodiment of the rotary flywheel turbine 100 of the present invention. Advantageously, an inlet port (such as 104) may be provided around the perimeter of the stator housing every twenty to thirty degrees or so.

As will be discussed in greater detail with respect to subsequent drawing figures, the stator housing 102 is operatively coupled to a source of vacuum, such as a vacuum pump or vacuum generator (FIG. 8), in a manner that will be known to those skilled in the art, such that the stator housing 102 can be subjected to a vacuum (i.e., such that gaseous pressure is less than atmospheric pressure) and such that steam can be exhausted from the housing 102, through the fluid outlet ports 108, 109.

FIG. 1 and FIG. 2 illustrate the outlet port 108 disposed on the lateral surface of the first end 114, and FIG. 2 illustrates the outlet port 109 disposed on the lateral surface of the second end 116, and the outlet ports 108, 109 are arranged to exhaust steam from the stator housing 102 by connection to a vacuum generator (shown schematically at FIG. 8) by tubing or piping 110, 111.

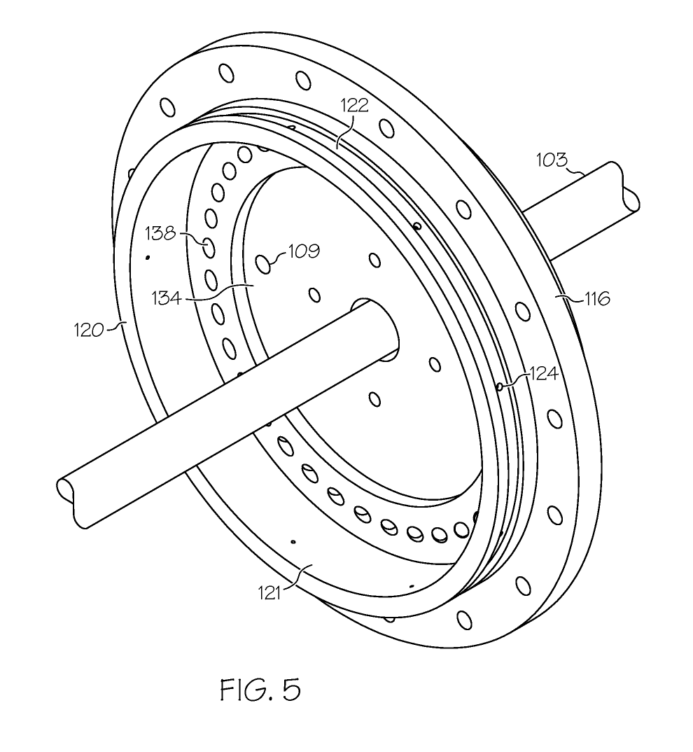

As shown in FIGS. 2, 3 and 5, the second end 116 of the stator housing 102 comprises a stationary ring 120 sized to closely fit within said first end 114 of the stator housing 102, said ring 120 having a channel 122 in alignment with the inlet ports 104, 105 of the first end 114 of the stator housing 102 for the flash and communication of steam along the perimeter of said ring 120, the channel 122 having a plurality of jet orifices 124 to direct jets of expanding steam into the space between the ring 120 of the second end 116 of the stator housing 102 and the peripheral surface of the rotary flywheel 101. The ring 120 and channel 122 act as an internal pressure header (shown schematically in FIG. 8). The stator ring 120 has a smooth inner surface 121 which is right cylindrical in shape. Nine jet orifices 124, evenly spaced at forty degrees about the perimeter of said ring 120 are shown in FIG. 5, but it is understood that at least one or more are provided and that more may be provided about the perimeter of the ring 120 of the second end 116 of the stator housing 102 according to another embodiment of the rotary flywheel turbine 100 of the present invention. Advantageously, a jet orifice may be provided every twenty to thirty degrees or so.

As shown in FIGS. 1, 2, and 3, the ring 120 of the stator housing 102 is sized to closely surround the rotary flywheel 101, and the rotary flywheel 101 comprises a plurality of inlet jet passages 126 (for the communication of steam) spaced circumferentially along the peripheral surface of the rotary flywheel 101, the openings of the inlet jet passages 126 being in alignment with the jet orifices 124 of the ring 120 of the stator housing 102, such that as heated condensate enters the stator housing 102 through the inlet ports 104, 105, it flashes to steam within the channel 122 of the stator ring 120 and expands through the jet orifices 124 and, in turn, into the inlet jet passages 126 of the rotary flywheel 101, thereby causing the rotary flywheel 101 to rotate by the force of the expanding and impinging steam.

As illustrated in FIG. 6 and FIG. 6A, each inlet jet passage 126 extends radially inward from the peripheral surface of the rotary flywheel 101, and is arranged such that, due to the expansive force of steam, the expansion of steam into the inlet jet passages 126 drives the rotary flywheel 101 and rotational shaft 103 to rotate in a unified rotational direction such as a counterclockwise direction CCW as illustrated by the arrow 127 in FIG. 6 and FIG. 6A.

As illustrated with broken lines in FIG. 6A, each inlet jet passage 126 preferably extends radially inward on an angle, which is not perpendicular to the peripheral surface of the rotary flywheel 101, such that the force of impinging steam causes the rotary flywheel 101 and rotational shaft 103 to rotate. Each inlet jet passage 126 has an entrance leading to a straight section of generally uniform transverse cross section. Each inlet jet passage 126 extends from the peripheral surface of the rotary flywheel 101 a rough distance equal to roughly one-twentieth to one-third the diameter of the rotary flywheel 101. Preferably, the axis of the straight section of the inlet jet passage 126 does not pass through the center axis of the rotary flywheel 101, but rather is on a tangent to an imaginary circle which is concentric with the rotary flywheel 101 axis. Preferably, each inlet jet passage 126 may extend radially inward on an angle which is between 30 and 60 degrees from the peripheral surface of the rotary flywheel 101.

As illustrated in FIGS. 6 and 6A, the plurality of inlet jet passages 126 are preferably arranged in a symmetrical pattern around the perimeter of the rotary flywheel 101; in this embodiment, there are a total of thirty-six inlet jet passages 126, each of these inlet jet passages 126 being 10 degrees from the two immediately circumferentially adjacent ones.

As illustrated in FIG. 6A, each inlet jet passage 126 merges into a first outlet jet passage 128 and a second outlet jet passage 130, for the communication and exiting of steam from the rotary flywheel 101, where the first and second outlet jet passages 128, 130 (also referred to as “retro jets” herein) extend laterally outward and are arranged such that the discharge of expanding steam from the outlet jet passages 128, 130 drives the rotary flywheel 101 and rotational shaft 103 in the same unified direction as the direction driven by expansion of steam into the inlet jet passages 126 such as the counterclockwise direction CCW illustrated by the arrow 127 in FIG. 6 and FIG. 6A. Preferably, each outlet jet passage 128, such as the outlet jet passage 128 illustrated with broken lines in FIG. 6A, may extend laterally outward on a 45 degree angle to the lateral surface of the rotary flywheel 101, such that the force of discharging steam causes the rotary flywheel 101 and rotational shaft 103 to rotate.

It can be seen in the embodiment in FIG. 6 and FIG. 6A, that rotational energy and power will be generated from both the expansion of steam into the inlet jet passages 126 disposed along the peripheral surface of the rotary flywheel 101 and the expansion and discharge of the steam exiting the outlet jet passages 128, 130 disposed along the lateral surfaces of the rotary flywheel 101. In this manner, a highly efficient and clean generation of power from flash steam and the expansion of steam is effected. In FIG. 6A, arrows 131 generally reflect the path of steam as steam enters each inlet jet passage 126 and exits the outlet jet passages 128, 130. By the expansion of the steam into the inlet jet passages 126 and exiting the outlet jet passages 128, 130, power is transferred from the steam to the rotary flywheel 101 in a highly efficient manner, resulting in additional rotational energy.

In addition, since the expansive force of the steam is applied to the perimeter of the rotary flywheel 101, an embodiment of the present invention provides an advantage of reduced breakaway torque as compared to prior art turbines.

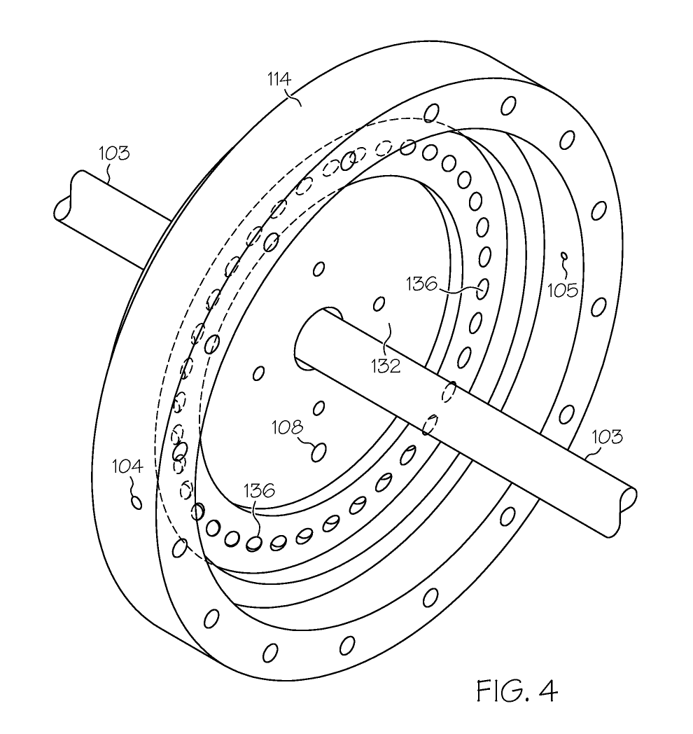

As shown in FIG. 4 and FIG. 5, the respective inner lateral walls 132, 134 of the stator housing are preferably provided with a plurality of small, evenly-spaced steps or depressions 136, 138 (also referred to as “flats”), which are oriented to present impact surfaces against which the steam exiting the outlet jet passages 128, 130 will strike. Broken lines are used in FIG. 4 to indicate that preferably the entire inner wall 132 of the first end 114 of the stator housing 102 will have steps 136 in alignment with the outlet jet passages 128 of the rotary flywheel 101. Similarly, while not illustrated with broken lines in FIG. 5, preferably the entire inner wall 134 of the second end 116 of the stator housing 102 will have steps 138 in alignment with the outlet jet passages 130 of the rotary flywheel 101.

The discharging of the steam from the plurality of correspondingly disposed outlet jet passages 128, 130 will cause the rotary flywheel 101 to rotate in reaction to the discharged steam. In the embodiment illustrated in FIG. 3, for each inlet jet passage 126, steam discharges from two outlet jet passages 128, 130, thereby resulting in enhanced reaction forces acting upon the rotary flywheel 101 by the discharging steam and multiple impingement upon at least two stator steps or depressions 136, 138 disposed along the respective lateral walls 132, 134 of the stator housing 102. In addition, the force of the discharged steam impacting a succession of the steps or depressions 136, 138 disposed along the respective lateral walls 132, 134 of the stationary stator housing 102 will drive the rotary flywheel 101 to rotate in a direction in unison with the direction of rotation as driven by the reaction to the discharged steam and as driven by the expansive force of the steam entering and impinging the inlet jet passages 126. In this manner, an embodiment of the present invention provides a clean generation of power from flash steam and the expansion of steam in a highly efficient manner.

The steps or depressions 136, 138 may take on a variety of shapes or configurations as impact surfaces. As shown in FIG. 4, the steps or depressions 136 are configured to present a substantially normal or right-angle flat surface relative to the direction of travel of the steam discharging from the outlet jet passages 128, 130. These steps or depressions may alternatively present a concave surface to receive a volume of discharged steam therein as the outlet jet passages 128, 130 respectively move to positions where they are adjacent to and facing the steps or depressions 136, 138.

The stator housing 102 is operatively coupled, in a manner that will be readily understood by those of ordinary skill in the art, to condensate lines 106, 107 which transport heated condensate to the turbine 100 from a source such as a boiler (FIG. 8). In addition, the stator housing 102 is operatively coupled to a source of vacuum, such as a vacuum pump or vacuum generator (FIG. 8), in a manner that will be known to those skilled in the art, such that the stator housing 102 can be subjected to a vacuum (i.e., such that gaseous pressure is less than atmospheric pressure) and such that steam can be exhausted from the housing 102, through the fluid outlet ports 108, 109. The vacuum within the stator housing 102 is preferably maintained at 29 inches of mercury. Referring to FIG. 8, upon exiting the stator housing 102 through the outlet ports 108, 109 to piping 106, 107, the working fluid (such as steam) is now a low pressure gas (or vapor) that flows to a condenser, where the working fluid undergoes a phase change again from vapor (or gas) to liquid, and in turn, is pumped back to the boiler and begins the cycle again, in a closed loop system. Exhaust steam may be vented to the atmosphere if desired.

A rotary shaft seal 142, such as a labyrinth seal or ring or an oil seal or a felt seal, is installed on a rotary shaft seal assembly 144, 146 on each side of the stator housing 102 for gas sealing at the axial ends of the stator housing 102, so as to prevent ingress of foreign matter such as gases or fluids from the exterior of the stator housing 102 and to prevent leakage of matter such as fluids or gases from the interior of the stator housing 102, such that a vacuum may be maintained within the stator housing 102. Typical labyrinth type rotary shaft seals are shown in Rockwood, et al., U.S. Pat. No. 4,572,517 and U.S. Pat. Nos. 4,022,479, 4,114,902, 4,175,752, 4,706,968 and 4,466,620, all to Orlowski, and U.S. Pat. No. 4,852,890 and U.S. Pat. No. 5,024,451, which are all incorporated herein by reference. Typical seals are illustrated in Exhibit A hereto. The rotary shaft seal assemblies 144, 146 are fixed to the stator housing 102 and can be secured to a stationary object by fasteners such as clamps 145, to hold the stator housing 102 in a stationary position and reduce vibration.

While it is preferable to utilize condensate and flash steam as the working fluid for an embodiment of the present invention, it can be appreciated that the working fluid can be any known working fluid, including but not limited to, water, accelerated steam, refrigerants, light hydrocarbons, and the like. It is noted that other gases or fluids could potentially be used with this rotary flywheel turbine 100, however the discussion herein, for illustrative purposes, focuses on the use of heated condensate and flash steam. A working fluid such as condensate is heated in a boiler (FIG. 8) and but does not change phase from a liquid to a vapor (or gas) phase due to a size restraint and high pressure within the boiler. The condensate is flowed from a boiler (FIG. 8) through piping 110, 111 to the stator housing 102 of the rotary flywheel turbine 100, and having gained the thermal energy, the heated condensate flashes to steam within the channel 122 of the stator housing 102 and reaches a higher energy state (i.e., vapor or gas phase) due to the vacuum within the stator housing 102. The working fluid is compressed (i.e., under pressure) having potential energy as it enters the rotary flywheel turbine 100 through the inlet ports 104, 105. Due to the physical constraint of the channel 122, the expanding steam reaches a high velocity and expands through the jet orifices 124 of the channel 122 and impinges into the inlet jet passages 126 of the rotary flywheel 101 and, in turn, discharges from the outlet jet passages 128, 130 of the rotary flywheel 101, thereby causing rotation of the rotary flywheel 101. After proceeding through the rotary flywheel turbine 100, the working fluid exits through the outlet ports 108, 109 having transferred potential energy to the rotary flywheel 101 and rotational shaft 103 creating kinetic energy. The rotational shaft 103 is preferably operatively coupled to a generator (shown schematically at FIG. 8), and the rotational shaft 103 provides input to the generator such that the generator can generate electrical power. Such generator is known in the art, and details of the generator will thus not be discussed.

Thermal energy is transferred to the working fluid, and power is transferred between such working fluid and the rotational shaft 103 from torque created by the forces of the expanding steam impinging upon and discharging from the rotary flywheel 101 due to the pressure of the working fluid (e.g., the expansion of the steam) which changes as it reaches a lower pressure. As illustrated in FIG. 8, an embodiment of the present invention may be used to produce rotational mechanical power from thermal energy sources. The rotational shaft 103 extends through the stator housing 102 and may be coupled to a generator (FIG. 8) that is designed to generate electricity from the rotating movement of a shaft, here, shaft 103 (FIG. 1 and FIG. 3).

This rotational mechanical energy can be used as a source of energy, for instance, to drive an electricity generator (shown schematically at FIG. 8), or to drive a prime mover (e.g., an engine) (shown schematically at FIG. 8), or to drive other devices. This rotational mechanical energy could also be used to drive a vacuum generator (FIG. 8) which is coupled to the rotary flywheel turbine 100. It should be readily appreciated that an embodiment of the flash steam turbine can function as a prime mover (e.g., as an engine) itself.

It should be noted that an embodiment of the present invention may also be operated without flashing heated condensate to steam within the stator housing 102. An embodiment of the present invention may be operated by utilizing boilers (having atomizing nozzles, heating elements and thermocouples)(shown schematically in FIG. 8) coupled to the rotary flywheel turbine 100, whereupon working fluid (such as water and steam) is flashed to steam within the boiler, changes from a liquid to a vapor, in the boiler and is transported (through tubing or piping 106, 107) into the stator housing 102 through inlet ports 104, 105 and is expanded through the rotary flywheel turbine 100. Alternatively, an embodiment of the present invention may be operated by utilizing an evaporator (shown schematically as a boiler in FIG. 8) coupled to the rotary flywheel turbine 100, whereupon working fluid (such as water and steam) is evaporated, changes from a liquid to a vapor, in the evaporator and is transported (through tubing or piping 106, 107) into the stator housing 102 through inlet ports 104, 105 and is expanded through the rotary flywheel turbine 100. Using either exemplary method, the expansion of the working fluid through the rotary flywheel turbine 100, and particularly through the inlet jet passages 126 and outlet jet passages 128, 130 of the rotary flywheel 101, drives the rotary flywheel turbine 100. The rotary flywheel turbine 100, in turn, drives an electric generator coupled to the rotary flywheel turbine 100. The generator produces electrical power. Referring to FIG. 8, upon exiting the stator housing 102 through the outlet ports 108, 109 to piping 106, 107, the working fluid (such as steam) is now a low pressure gas (or vapor) that flows to a condenser, where the working fluid undergoes a phase change again from vapor (or gas) to liquid, and in turn, is pumped back to the boiler or evaporator and begins the cycle again, in a closed loop system. Exhaust steam may be vented to the atmosphere if desired. The working fluid is then pumped back to the boiler or evaporator and begins the cycle again.

It should be noted that an alternative embodiment of the present invention may also be operated by utilizing conventional spray nozzles that direct high velocity steam toward an embodiment of the rotary flywheel 101, whereupon the steam would impinge into the inlet jet passages 126 of the rotary flywheel 101 and, in turn, discharge from the outlet jet passages 128, 130 of the rotary flywheel 101, thereby causing rotation of the rotary flywheel 101.

As shown in FIGS. 1, 2, 3, 6 and 7, the rotary flywheel 101 has a bulk of its mass concentrated in an annulus 150 at the periphery in order to give the rotary flywheel a high radius of gyration so that it functions well as a flywheel. The annulus is concentrically connected to the rotational shaft 103 by a web 152. In the embodiment in FIG. 6, the web 152 has at its center a hub 154 which is fastened to the rotational shaft 103 by bolts. Preferably, the web 152 has a plurality of holes 156 which allow for the equalization of gaseous pressure on both sides of the rotary flywheel 101. If the web 152 was as wide as the annulus 150, the rotor would be a solid right cylinder, the radius of gyration of which would be 0.7 times the radius of the rotor. While the rotor may have other shapes, it is desirable that the radius of gyration be 0.7 times the radius or greater, and preferably that it have its mass concentrated in an annulus at the periphery of the rotary flywheel 101 as shown in FIG. 6. In any case, the outer surface of the rotor, and preferably of the rotary flywheel 101 shown in FIGS. 1, 2, 3, 6 and 7, is machined as a right cylindrical surface, which is apposed to the smooth concentric right cylindrical inner surface of the stator ring 120 of the stator housing 102.

It should be appreciated that the rotary flywheel 101 can be cast as one member, thereby reducing the number and cost of parts which must be fabricated and assembled, while also avoiding the use of fragile blades for the transfer of thermal energy to rotational mechanical energy.

The rotary flywheel 101 is concentrically connected to the rotational shaft 103 such that the two components form an integrated rotational assembly. The rotational shaft 103 extends throughout the length of the stator housing 102 and passes through the first end 114 and second end 116 of the stator housing 102. The longitudinal axis of the rotational shaft 103 is parallel to and concentric with the longitudinal axis of the stator housing 102, thereby avoiding balancing problems associated with conventional turbines having an offset axis arrangement. The rotational shaft 103 passes through and is supported by low-friction, rotational shaft support bearings 148.

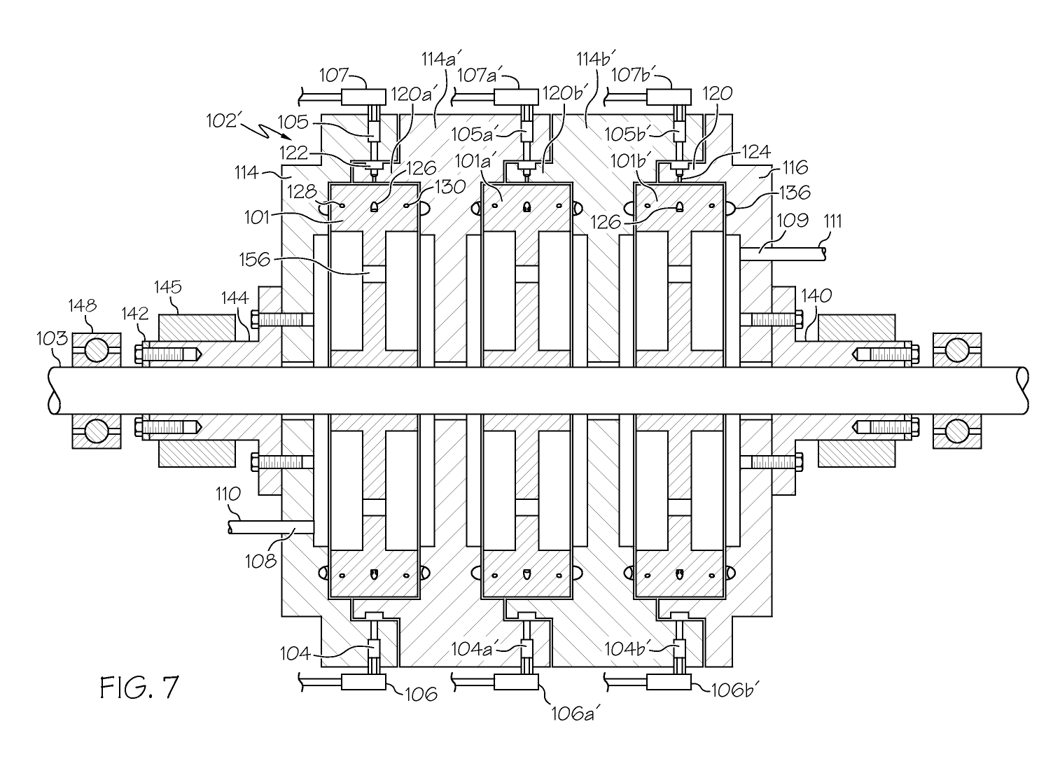

FIG. 7 illustrates another preferred embodiment of the flash steam powered rotary flywheel turbine of the present invention, in an embodiment comprising more than one rotary flywheel. FIG. 7 shows a modification of the rotary flywheel turbine 100 of FIGS. 1, 2, and 3, with the same parts bearing the same reference numerals as those used in FIGS. 1, 2, and 3 except that a single apostrophe is added to each of the reference numerals of modified or additional parts. Similar to the embodiment in FIGS. 1, 2, and 3, this embodiment comprises a stator housing 102′ having a first end 114 and a second end 116. The main or basic difference in this embodiment from that of FIGS. 1, 2, and 3 is that this embodiment comprises a first rotary flywheel 101, a second rotary flywheel 101a′, and a third rotary flywheel 101b′, fixed to a rotational shaft 103, and comprises further a first partition 114a′ disposed between the first rotary flywheel 101 and the second rotary flywheel 101a′, and a second partition 114b′ disposed between the second rotary flywheel 101a′ and the third rotary flywheel 101b′, as illustrated in FIG. 7.

As shown in FIG. 7, the first partition 114a′ of the stator housing 102′ is a modification of the first end 114 of the stator housing 102 such that the first partition 114a′ comprises a stationary ring 120a′ (having a channel 122) on the side of the first partition 114a′ apposed the first rotary flywheel 101, said ring 120a′ having structure similar to the ring 120 of the second end 116 of the stator housing 102′. The first partition 114a′ further comprises first and second inlet ports 104a′, 105a′ on the side of the first partition 114a′ apposed the second rotary flywheel 101a′ for the communication of heated condensate into the stator housing 102′ by connection to a source (FIG. 8) by tubing or piping 106a′, 107a′.

As shown in FIG. 7, the second partition 114b′ is of the same structure as the first partition 114a′.

In this FIG. 7 embodiment, as was the case in the foregoing embodiment in FIGS. 1, 2, and 3, heated condensate is supplied by a source such as a boiler (FIG. 8), in a manner that will be known in the art, such that heated condensate can be supplied through piping or tubing 106, 107 to and through the fluid inlet ports 104, 105 aligned with the first rotary flywheel 101, as shown in FIG. 7. In a similar manner, heated condensate can be supplied through piping or tubing 106a′, 107a′ to and through the fluid inlet ports 104a′, 105a′ aligned with the second rotary flywheel 101a′. In a similar manner, heated condensate can be supplied through piping or tubing 106b′, 107b′ to and through the fluid inlet ports 104b′, 105b′ aligned with the third rotary flywheel 10lb′. Preferably, one or more main control valves may be disposed within each condensate line 106, 107; 106a′, 107a′; 106b′, 107b′ such that the introduction of heated condensate to each of the rotary flywheels 101, 101a′, 10lb′ may be independent. The working fluid is compressed (i.e., under pressure) having potential energy as it enters the modified stator housing 102′ through the inlet ports 104, 105; 104a′, 105a′; 104b′, 105b′. Due to the physical constraint of the channels 122 of the respective rotary flywheels 101, 101a′, 101b′, the expanding steam reaches a high velocity and expands through the jet orifices 124 of the respective channels 122 and impinges into the respective inlet jet passages 126 of the respective rotary flywheels 101, 101a′, 101b′ and, in turn, discharges from the respective outlet jet passages 128, 130 of the rotary flywheels 101, 101a′, 101b′ thereby causing rotation of the respective rotary flywheels 101, 101a′, 101b′. After proceeding through this embodiment of the rotary flywheel turbine (FIG. 7), the working fluid exits through the outlet ports 108, 109 having transferred potential energy to the rotary flywheels 101, 101a′, 101b′ and rotational shaft 103 creating kinetic energy. The rotational shaft 103 may provide an input to a generator (shown schematically at FIG. 8) such that a generator can generate electrical power. Alternatively, the rotational shaft 103 may provide input to drive a prime mover.

Having more than one rotary flywheel allows for the generation and storage of additional rotational energy. In addition, having more than one rotary flywheel allows for an embodiment of the rotary flywheel turbine to be slowed down or reversed by configuring at least two rotary flywheels to rotate in opposing directions. This may be accomplished, for example, by orienting the inlet jet passages 126 and outlet jet passages 128, 130 of the first rotary flywheel 101 in FIG. 7 such that the first rotary flywheel 101 rotates in a counterclockwise direction CCW, and orienting the inlet jet passages 126 and outlet jet passages 128, 130 of the second rotary flywheel 101a′ in FIG. 7 to be opposite the inlet jet passages 126 and outlet jet passages 128, 130 of the first rotary flywheel 101 in FIG. 7 such that the second rotary flywheel 101a′ in FIG. 7 rotates in a clockwise direction CW. Thus, in this example, after the first rotary flywheel 101 is rotating in a counterclockwise CCW direction, driven by the flash and expansion of steam, as a result of a continuous introduction of heated condensate through the stator inlet ports 104, 105 aligned with the first rotary flywheel 101, in turn, the introduction of heated condensate through the stator inlet ports 104a′, 105a′ aligned with the second rotary flywheel 101a′ would, by the flash and expansion of steam, exert a force upon the second rotary flywheel 101a′ such that the second rotary flywheel 101a′ is driven to rotate in a clockwise rotation, which is an opposite direction. Thus, it can be said that the second rotary flywheel 101a′ may act as a braking mechanism. In such an embodiment, to the extent that a second rotary flywheel is used as a braking mechanism, it would provide an advantage of not relying on disc brakes, and accordingly, there would be much less material waste. By orienting the inlet jet passages 126 and outlet jet passages 128, 130 of the third rotary flywheel 101b′ in FIG. 7 such that the third rotary flywheel 101b′ rotates in a counterclockwise direction CCW, this exemplary embodiment allows for the generation and storage of additional rotational energy, by having two rotary flywheels 101, 101b′ rotate in the same direction.

Further, since the rotational speed of the rotary flywheel may be controlled (and increased or decreased) by independent operation of main control valves within each condensate line 106, 107; 106a′, 107a′, 106b′, 107b′ there is no need for any high speed reduction gear reducers or electronics. Further, in such an embodiment, to the extent that a second rotary flywheel is used as a reversing mechanism, it would provide an advantage of a simplified reversing mechanism without transmission gears and clutches, and accordingly, is less complex and less expensive to manufacture and maintain.

By using a rotary flywheel 101 of an embodiment of the present invention, and by utilizing flash steam and the expansion of steam within the stator housing 102, the rotary flywheel turbine 100 of the present invention is more efficient than conventional steam turbines and is better suited for power generation and power storage applications, while maintaining reduced mechanical complexity and superior power density. Such an embodiment is not limited in power and efficiency by the velocity of steam that is streamed from a nozzle aimed at the turbine rotor.

Using an embodiment of the present invention, waste heat is a renewable resource and an important recycled energy option. Using an embodiment of the present invention to convert waste heat into electricity can reduce the consumption of fossil fuels, improve energy security, and limit society's impact on the environment.

It is to be understood that the invention is not to be limited to the exact details of operation or structure shown and described, as obvious modifications and equivalents will be apparent to one skilled in the art.

While various embodiments of the present invention have been described above, it should be understood that they have been presented by way of example only, and not limitation. It will be understood by those skilled in the art that various changes may be made and equivalents may be substituted for elements thereof without departing from the scope of the invention.

All patents and publications discussed herein are incorporated in their entirety by reference thereto.

What is claimed is:

1. A rotary flywheel turbine comprising:
a rotary flywheel fixed to a rotational shaft, wherein said flywheel comprises a plurality of inlet jet passages spaced circumferentially along the peripheral surface of said flywheel;
wherein each inlet jet passage extends radially inward from the peripheral surface of said flywheel for the communication of steam into said flywheel, and wherein each inlet jet passage merges with one or more outlet jet passages extending laterally outward toward the lateral surface of the flywheel for the discharge of steam from the flywheel;
a stationary stator housing sized to closely and securely surround said flywheel;
said stator housing comprising a first end and a second end and a means for securing together the first end and the second end;
wherein the first end comprises a plurality of inlet ports disposed around the perimeter of said first end for the communication of heated condensate into the stator housing;
wherein the second end having a stationary ring sized to closely fit within said first end, wherein said ring comprises a channel for the flash and communication of expanding steam along the outer perimeter of said ring in which a plurality of jet orifices are arranged about the periphery of said ring to direct jets of expanding steam into the space between said stator housing and the periphery of said flywheel; and,
wherein said stator housing having at least one exhaust outlet port to exhaust an expanded steam.

2. The rotary flywheel turbine of claim 1, wherein the inlet jet passages are oriented to receive expanding steam in order to effect flywheel rotation when steam is impinged thereto.

3. The rotary flywheel turbine of claim 1, wherein the outlet jet passages are oriented to produce a jet effect in order to effect flywheel rotation when steam is discharged therefrom.

4. The rotary flywheel turbine of claim 1, wherein the inlet jet passages are oriented on an axis along a line which is tangent to an imaginary circle concentric with the axis of rotation.

5. The rotary flywheel turbine of claim 1, wherein each inlet jet passage merges with two outlet jet passages respectively extending laterally outward toward each lateral surface of the flywheel for the discharge of steam from the flywheel;

6. The rotary flywheel turbine of claim 1, wherein the inlet jet passages and outlet jet passages are arranged and oriented in a symmetrical manner around the flywheel.

7. The rotary flywheel turbine of claim 1, wherein the stator housing is subject to a vacuum maintained by a connection to a vacuum generator.

8. The rotary flywheel turbine of claim 1, wherein said stator housing comprises a rotary shaft seal on each axial end of the stator housing for the purpose of gas sealing at the axial ends of the stator housing.

9. The rotary flywheel turbine of claim 1, wherein said stator housing further comprises a plurality of steps provided on the inner walls thereof, wherein said steps are so constructed and arranged to present impact surfaces against which expanding steam exiting said outlet jet passages of said flywheel will strike;

10. The rotary flywheel turbine of claim 9, wherein said steps are so constructed and arranged to present surfaces which are substantially perpendicular to a direction of travel of expanding steam exiting said outlet jet passages.

11. The rotary flywheel turbine of claim 9, wherein said step surfaces further include a concave depression for receiving ejected steam.

12. The rotary flywheel turbine of claim 1, wherein said rotational shaft is supported by bearings which permit the rotary flywheel to freely rotate.

13. The rotary flywheel turbine of claim 1, wherein said rotational shaft is operatively coupled to an electrical generator.

14. The rotary flywheel turbine of claim 1, wherein said rotational shaft is operatively coupled to a prime mover.

15. The rotary flywheel turbine of claim 1, wherein said rotational shaft is operatively coupled to a drive train.

16. A rotary flywheel turbine comprising:
a rotary flywheel fixed to a rotational shaft, said flywheel comprising a plurality of inlet jet passages spaced circumferentially along the peripheral surface of said flywheel, each inlet jet passage extending radially inward from the peripheral surface of said flywheel for the communication of working fluid into said flywheel, each inlet jet passage merging with one or more outlet jet passages extending laterally outward toward the lateral surface of the flywheel for the discharge of working fluid from the flywheel;
a stationary stator housing sized to closely surround said flywheel, said stator housing comprising a first end and a second end and a means for securing together the first end and the second end; the first end having a plurality of ports disposed around the perimeter of said first end for the communication of working fluid into the stator housing; the second end having a stationary ring sized to closely fit within said first end, said ring having a channel for the communication of working fluid along the outer perimeter of said ring in which a plurality of jet orifices are arranged about the periphery of said ring to direct jets of working fluid into the space between said stator housing and the periphery of said flywheel; and
wherein said stator housing having at least one exhaust outlet port to exhaust a working fluid.

17. The rotary flywheel turbine of claim 16, wherein the inlet jet passages are oriented to receive expanding steam in order to effect flywheel rotation when steam is impinged thereto.

18. The rotary flywheel turbine of claim 16, wherein the outlet jet passages are oriented to produce a jet effect in order to effect flywheel rotation when steam is discharged therefrom.

19. The rotary flywheel turbine of claim 16, wherein each inlet jet passage merges with two outlet jet passages respectively extending laterally outward toward each lateral surface of the flywheel for the discharge of steam from the flywheel;

20. A rotary flywheel turbine comprising:
a stator housing having an inlet nozzle to introduce a jet stream of a working fluid, and an outlet to exhaust an expanded fluid;
a rotary flywheel fixed to a rotational shaft disposed in said stator housing, said flywheel comprising a plurality of inlet jet passages spaced circumferentially along the peripheral surface of said flywheel, each inlet jet passage extending radially inward from the peripheral surface of said flywheel for the communication of working fluid into said flywheel, each inlet jet passage merging with one or more outlet jet passages extending laterally outward toward the lateral surface of the flywheel for the discharge of working fluid from the flywheel, causing a rotation of the flywheel;

21. The rotary flywheel turbine of claim 20, wherein said rotary flywheel turbine is operatively coupled to a supply system for supplying pressurized fluid to said rotary flywheel.

22. A method of using flash steam to power a rotary flywheel turbine, comprising:
harnessing waste heat produced from a prime mover;
directing said waste heat to a boiler coupled to said rotary flywheel turbine;
transferring thermal energy from said waste heat to condensate contained in said boiler;
directing said condensate to the rotary flywheel turbine fluidly coupled to said boiler;
flashing said condensate to steam within the rotary flywheel turbine coupled to said boiler;
creating rotational mechanical energy in said rotary flywheel turbine using said flash steam;
transferring said rotational mechanical energy to an electricity generator via a shaft of said rotary flywheel turbine;
exhausting expanded steam from the rotary flywheel turbine; and
directing said expanded steam to a condenser for transforming said steam to condensate, said condenser fluidly coupled to said rotary flywheel turbine.

23. A method of using a rotary flywheel turbine, comprising:
harnessing waste heat produced from a prime mover;
directing said waste heat to an evaporator coupled to said rotary flywheel turbine;
transferring thermal energy from said waste heat to a working fluid contained in said evaporator;
evaporating said working fluid from a liquid form to a vapor form in an evaporator;
directing said vapor form of said working fluid through the rotary flywheel turbine fluidly coupled to said evaporator;
creating rotational mechanical energy in said rotary flywheel turbine using said vapor form of said working fluid;
transferring said rotational mechanical energy to an electricity generator via a shaft of said rotary flywheel turbine; and
directing said vapor form of said working fluid to a condenser for condensing said vapor form of said working fluid to said liquid form of said working fluid in the condenser, said condenser fluidly coupled to said rotary flywheel turbine.
